(19) United States
(12) Patent Application Publication
(10) Pub. No.: US 2022/0012990 A1
(43) Pub. Date: Jan. 13, 2022

(54) PERIPHERAL VISION NOTIFICATION SYSTEM AND METHOD

(71) Applicants: Angelo Tortola, Lexington, MA (US); Charles S. Sebor, Reading, MA (US); Avi Nelson, N. Reading, MA (US)

(72) Inventors: Angelo Tortola, Lexington, MA (US); Charles S. Sebor, Reading, MA (US); Avi Nelson, N. Reading, MA (US)

(21) Appl. No.: 17/317,350

(22) Filed: May 11, 2021

Related U.S. Application Data
(60) Provisional application No. 63/050,238, filed on Jul. 10, 2020.

(51) Int. Cl. G08B 5/38; G08B 21/22; G02B 27/01; H05B 47/19

(52) U.S. Cl. CPC G08B 5/38; G08B 21/22; G02B 2027/0178; H05B 47/19; G02B 27/0172

(57) ABSTRACT

The present invention provides a body worn or body connected peripheral vision notification method and system to provide a visual indication to the person of limb or body movement or position. The system and method make use of a simple device which typically can be worn on the wrist or ankle of the user and which provides a visual warning or notification to the user while the user is engaged in various activities or actions. As one example, the invention provides a visual warning that the user may be about to touch his or her face with the hand. Such a warning can cause the user to refrain from touching the face. As another example, a wrist worn device in accordance with the invention can signal to a user the correct positioning of arms and hands for training in hitting a baseball. As a further example, an ankle worn device can signal foot position to monitor a person's stride. In another aspect, the device is on an object associated with a user and the position of the object is detectable by the user when the object comes into peripheral view.

### BACKGROUND OF THE INVENTION

It is useful to detect movement of a person's limbs or body and to provide a warning or a notification to the person of that movement. As an example, notification of movement of a person's hand toward the face can warn the person of a face touch, which could cause transfer of germs or other contaminants from the person's fingers or hand to the face. As another example, movement of the arms or positioning of the arms in an intended position can be denoted to provide training of a golf swing or of hitting a baseball. Detection of movement of a person's feet can provide an indication of proper stride for a runner.

### SUMMARY OF THE INVENTION

According to the invention, in one aspect, at least one light source is disposed on a user's wrist, ankle or other body part and configured to emit light which becomes visible to the user when the wrist, ankle or other body part carrying the light source moves into the peripheral field of the user.

In another aspect, at least one light source is disposed on an object used by or associated with a user and configured to emit light which becomes visible to the user when the object moves into the peripheral visual field of the user.

The acuity of human peripheral vision is only about 20/200 but is sufficient to detect light coming into peripheral view by reason of sensitivity to change and sensitivity to color.

In one embodiment, a device in accordance with the invention is contained within a wristband adapted to be worn on the wrist of the user and containing at least one light source mounted in a position to emit light visible in the peripheral field of a wearer during movement or positioning of the user's hand or arm. The light source is typically a light emitting diode (LED) which is recessed or partially shielded in a portion of the wrist band to limit the visible light viewable by the wearer, until the wearer's hand or arm moves along an intended path to become visible in the peripheral visual field of the wearer. The light source may emit light of any suitable color, which may be fixed or flashing to enhance visibility.

In another embodiment, a device in accordance with the invention is contained in an ankle band or strap adapted to be worn about the ankle of a wearer.

In a further embodiment, a device in accordance with the invention is disposed on an object used by or associated with the user, which may be for example, a gold club, baseball bat, tennis racket or other sports object, or a music conductor's baton, ballet slippers and the like.

The light source is powered by a battery operating control circuit disposed in a housing which can be attached to or incorporated in a wrist band, ankle band or other body or device attachment.

### BRIEF DESCRIPTION OF THE DRAWINGS

The invention will be more fully understood from the following detailed description in conjunction with the accompanying drawings, in which:

FIG. 1 is a pictorial view of a wrist band in accordance with the invention and shown on a user's wrist;

FIG. 2 is a pictorial view of the wrist band in an uninstalled position;

FIG. 3 is an enlarged cutaway pictorial view of a portion of the wrist band showing placement of the LED lamps;

FIG. 4 is an exploded view of a portion of the wrist band showing the LED assembly and strip wiring;

FIG. 5 is a pictorial view of an embodiment of the invention implemented in an eye glass frame;

FIG. 6 is another pictorial view of another embodiment of the invention implemented on a golf putter;

FIG. 7 is another pictorial view showing the device on a golf putter; and

FIGS. 8A, 8B and 8C are, respectively, elevated, side and top views the device of FIGS. 6 and 7.

### DETAILED DESCRIPTION OF THE INVENTION

This patent application claims priority from U.S. Provisional Application No. 63/050,238, filed Jul. 10, 2020, the disclosure of which is incorporated by reference herein in its entirety.

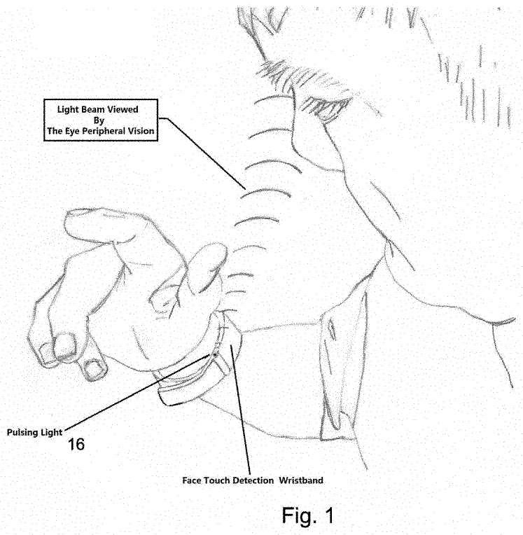

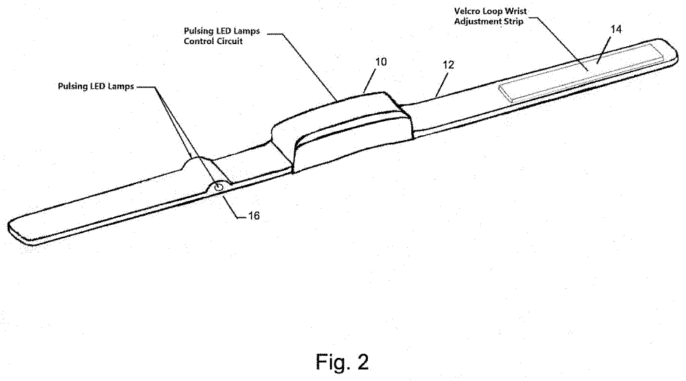

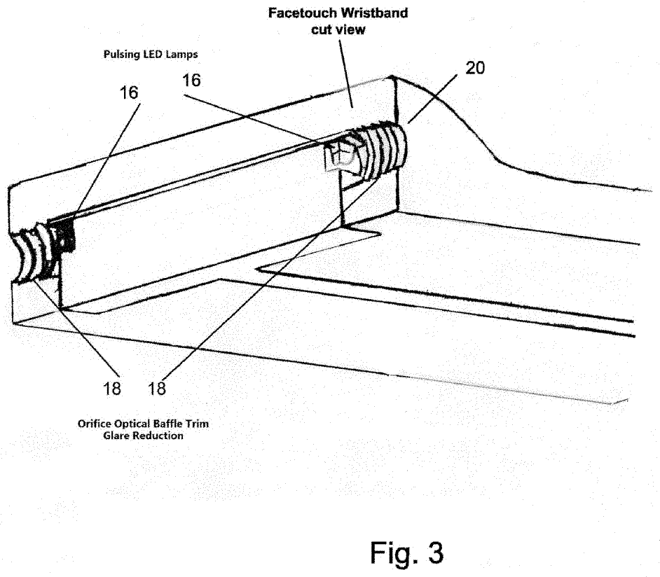

FIG. 1 shows a wrist band on a user's or wearer's wrist and containing a device according to the invention. The band and device off the wrist is shown in FIG. 2. The device in the illustrated embodiment includes a housing 10 containing a control circuit and battery source and a flexible band 12 having a hook and loop type closure 14 on the ends thereof and an LED lamp 16 positioned on each side of the band to provide visibility whether device is worn on the right or the left wrist. The LEDs are positioned in a shielded manner to be preferentially visible to the wearer when the wearer's hand moves toward the face. In one embodiment, shown in FIG. 3, each LED 16 is recessed in the band at the inner end. A shield or baffle 18 is provided in each recessed opening, and the recessed opening can have stepped ridges 20 to deflect light from the LED. The openings are preferably non-reflective to provide effective shielding of light from the LEDs. The LEDs can provide light of a color to enhance visibility, and can be pulsed or flashing to enhance visibility.

The band 12 or a portion thereof can be of sufficient thickness to contain the control circuit and battery within a section thereof, without need for a separate housing as in FIGS. 1 and 2.

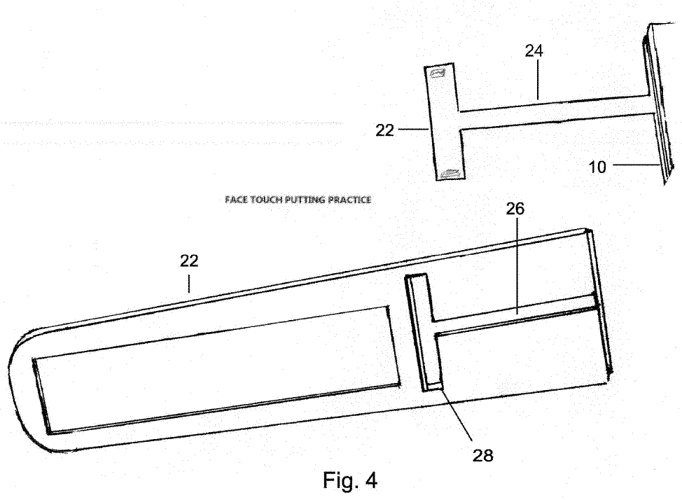

The device can be incorporated on a wrist band in a variety of ways. One implementation is shown in FIG. 4 which is an exploded view of the wrist band 12 having recesses 26 and 28 for accepting strip circuit 24 and LED assembly 22, respectively. A cover layer (not shown) can be placed over the installed strip circuit and LED assembly to protect and secure those items.

The invention may alternatively be embodied in a wristwatch or smart watch. The LEDs 16 are electrically connected to printed circuit traces disposed in the band, and which are connected in the housing to the control circuitry.

In the illustrated embodiment, two LEDs 16 are shown, although a single LED, or more than two LEDs, may be provided in alternative embodiments. The control circuit contained in housing 10 is preferably an integrated circuit powered by one or more battery cells and operative to power the LEDs. The control circuit can provide pulse power to the LEDs to cause flashing of the LEDs for increased visibility to a wearer. An on-off switch can be provided for the control circuit, or the circuit can be energized automatically such as by placement of the wrist band on a user's wrist. The means for such automatic activation are known.

In use, light from the LEDs is not readily visible to a wearer during usual hand use such as during walking, writing, typing and the like. If the wearer raises his or her hand toward the wearer's face, the light from the LEDs becomes visible in the peripheral visual field of the wearer and serves to warn the wearer not to touch the face.

In another embodiment, the wrist worn device is worn by a baseball batter and includes a flashing LED positioned such that the light is seen by the batter during his/her swing. In use, a batter focuses on an incoming ball thrown by a pitcher. The peripheral vision of the batter is utilized to inform the batter about hand position during a completed swing. The LED is preferably red and flashing which increases the wearer's ability to see the light in their peripheral vision. As an example of usage, a right-handed batter may decide that he wants his hands out in front of the swing (closer to the pitcher than the bat head is), because he has decided that he wants to hit to right field. The persistence of the LED image noticed peripherally at the point of impact with the ball will inform the batter about his level of success in maintaining the desired hand position, and allow the batter to adjust his approach to better attain the desired goal. The device may also be employed for other sports movements, such as tennis, boxing, gymnastics, bowling and the like.

A wrist band embodiment such as shown in FIGS. 1-4, can also be used to signal to a user when their hand is raised to the face to eat, thereby alerting the user to be mindful of their eating. The band may include sensing technology that detects the rise of a hand. The device can include one or more LEDs located near the thumb of the user on the body facing side of the wrist band. This position limits the visibility of the light to the user and minimizes light visible by others. Viewing privacy is realized by proper LED placement and by baffling used to direct light to only the wearer.

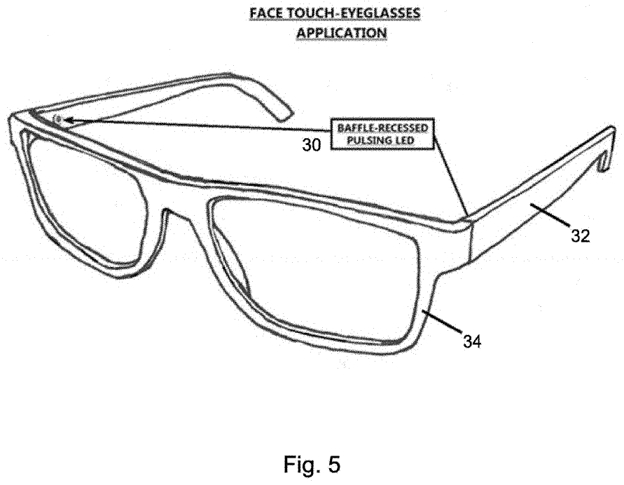

Another embodiment is shown in FIG. 5 wherein an LED 30 is contained in the left and right temples 32 of an eyeglass frame 34. The associated circuitry is disposed in the frame and is wirelessly connected to a smartphone such as using Bluetooth. Either or both LEDs located on the eyeglass temples can be used to provide signals visible in the wearer's peripheral visual field. The signals may be used for various purposes. As an example, a biker using a map application on the phone can be signaled about his destination without taking eyes off the road.

The embodiment of FIG. 5 can be employed to convey direction information to a user while driving a vehicle. Navigation systems in cars provide visual and audible instructions via an onscreen map or audible prompts, but these can distract the driver's attention. The present invention can provide navigation instructions with little or no driver distraction. As an example, the left LED on the eyeglass frame can flash to indicate a left turn, and the right LED can flash to indicate a right turn. The absence of any flashing LED can signify that no turns are required. The device controlling the LEDs on the eyeglass frame is in wireless communication with the GPS system in the vehicle to provide the turn indication data.

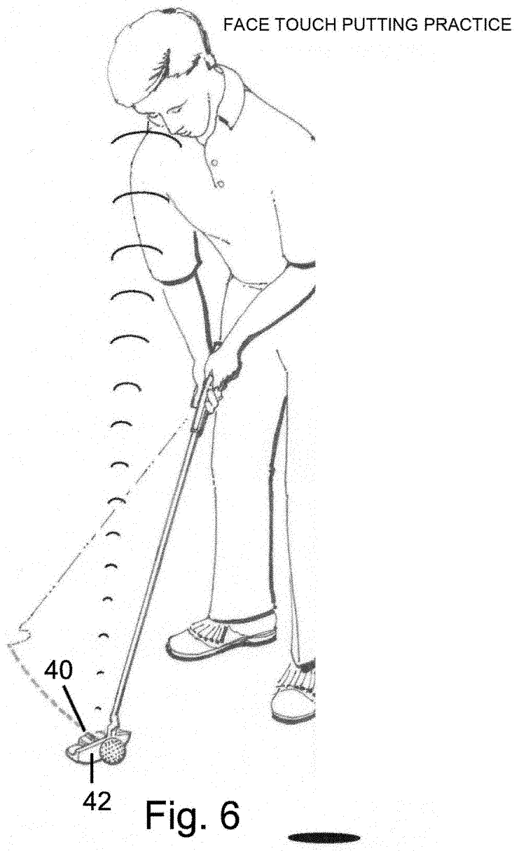

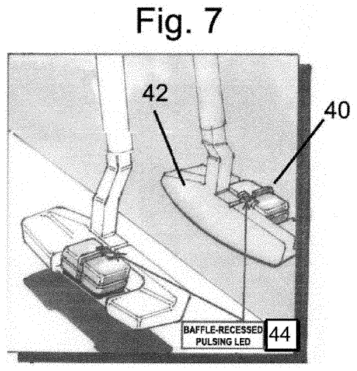

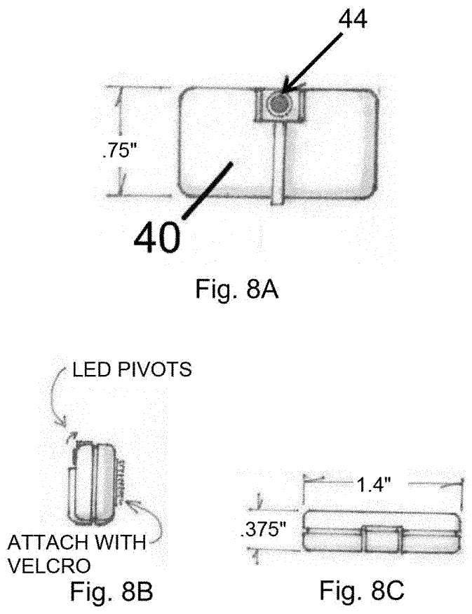

A further embodiment is shown in FIGS. 6, 7 and 8A, 8B and 8C, in which a module 40 in accordance with the invention is mounted on a golf putter 42. The module has an LED 44 located on the top of the module case which when installed on the putter emits light seen in the peripheral vision of the golfer during a swing. The module is typically attached to the putter by a hook and loop fastener. Preferably, the light from the LED is flashing and of sufficient intensity to create an image of the swing by virtue of the peripheral vision persistence of the golfer's eyes. The golfer can see and adjust the swing accordingly. The module can be used with other golf clubs other than putters.

A further embodiment of the invention is realized in an ankle worn band that signals to a runner their success or failure to perform within desired parameters. A module that contains one or more LEDs is positioned on the band to provide light visible to the runner. Signal circuitry is provided to detect impact of a foot upon a running surface, a GPS to monitor location, and Bluetooth or other wireless signaling to receive personalized measurement data from the wearer's smartphone. The device can be implemented to monitor the runners speed, stride, length, or intensity of foot impact. The runner's performance in comparison to a predetermined set of data, is signaled privately to the runner by a flashing LED located on the upside of the ankle band, and visible in the peripheral vision of the runner. The peripheral vision is especially sensitive to detection of flashing lights. Proper LED placement and baffling such as described herein is provided to limit by visibility of the light to only the user. The signaling scheme can use multi-colored lights. For example, the LED can flash every few seconds with a green color used to indicate success with desired parameters, and a red color to indicate variance from desired parameters.

The invention may be embodied in many different forms using a variety of materials which per se are well known, and may be utilized in various activities in which the motion and/or position of a body part or object associated with the body is of interest. Accordingly, the invention is not to be limited by the embodiment described above but is to embrace the spirit and full scope of the claims.

1. A personal visual system comprising:
a device adapted to be attachable to a part of the body of a user or on an object associated with a user and having at least one visible light source;
the at least one light source mounted in the device in a position to emit light which becomes visible to the user when the part of the user's body having the device or object having the device moves into the peripheral visual field of the user.

2. The system of claim 1 wherein the device is attachable to a wrist of a user.

3. The system of claim 1 wherein the light source includes a control circuit in the device and operative to power the light source.

4. The system of claim 1 wherein the device is attachable to an ankle of a user.

5. The system of claim 1 wherein the device is an eyeglass frame wearable by a user.

6. The system of claim 1 wherein the control circuit is operative to provide pulsed power to the at least one light source to cause flashing of the at least one light source.

7. The system of claim 1 wherein the at least one light source is an LED.

8. The system of claim 1 including a shield associated with the at least one light source and operative to partially occlude light from the light source visible to a wearer of the device.

9. A method for providing a personal visual alert to a user comprising the steps of:
providing a device attachable on a part of the body of a user, or on an object associate with a user;
the device having at least one visible light source;
positioning the light source to emit light which becomes visible to the user when the part of the user's body having the device or object having the device moves into the peripheral visual field of the user.

10. The method of claim 9 wherein the providing step includes providing the device attachable to the wrist of a user.

11. The method of claim 9 wherein the providing step includes providing the device attachable to the ankle of a user.
